(19) United States
(12) Patent Application Publication
(10) Pub. No.: US 2017/0118930 A1
(43) Pub. Date: May 4, 2017

(54) Systems and Methods for Sensing Precipitation

(71) Applicant: Telsco Industries, Inc. d/b/a Weathermatic, Garland, TX (US)

(72) Inventors: Venkataramu L. Bangalore, Plano, TX (US); Michael Rene, Garland, TX (US); Michael McCafferty, Garland, TX (US); Lex Michael Mason, Garland, TX (US)

(21) Appl. No.: 15/336,456

(22) Filed: Oct. 27, 2016

Related U.S. Application Data
(60) Provisional application No. 62/249,007, filed on Oct. 30, 2015.

(51) Int. Cl. A01G 25/16; G05D 7/06; G05B 15/02; G01W 1/14; G01N 27/12

(52) U.S. Cl. CPC A01G 25/167; G01W 1/14; G01N 27/121; G05B 15/02; G05D 7/0635

(57) ABSTRACT

A precipitation sensor including: an outer housing having a top portion and forming the first cavity, and inside of the first cavity including a variable-permittivity medium that is exposed at a top of the first cavity; first and second conductive plates extending along at least part of a vertical dimension of the first cavity, the first conductive plate and the second conductive plate disposed so that the variable-permittivity medium separates opposing surfaces of the first conductive plate and the second conductive plate; the outer housing having a bottom portion forming a second cavity, the second cavity including means for measuring an electromagnetic characteristic of a capacitor formed by the first conductive plate, the second conductive plate, and the variable-permittivity medium.

### CROSS-REFERENCE TO RELATED APPLICATIONS

This application claims the benefit of U.S. Provisional Application No. 62/249,007, filed Oct. 30, 2015, entitled “Systems and Methods for Sensing Precipitation,” the contents of which are expressly incorporated by reference herein

### TECHNICAL FIELD

This application relates to precipitation sensing and, more specifically, to precipitation sensors employing variable-permittivity media.

### BACKGROUND

Automatic sprinkling systems are well known in the art. These systems typically operate in a manner where the user specifies a certain time for starting a watering cycle as well as a length of time that each specified watering cycle (in perhaps each of a number of watering zones) should last. In most situations, the user makes an initial best guess as to the watering needs of the vegetation, and sets a watering time based on that guess. Thereafter, the user monitors the health of the plants and condition of the soil in each watering zone to make adjustments to the initial guess as to watering needs and causing corresponding adjustments to the specified watering time for each zone. Ideally, an automatic sprinkler system should return to the vegetation only as much water as has been lost through either evaporation from the soil or transpiration from the plant. This manual guessing process for specifying sprinkling durations is notoriously inaccurate. In fact, some estimates indicate that automatic sprinkler users over-water their vegetation by as much as a thirty to forty percent (30-40%) factor.

The term “evapotranspiration” (ET) refers to the amount of water a plant uses or needs in order to maintain growth. The climatic information commonly used to calculate an evapotranspiration value include temperature, solar radiation, wind speed, and vapor pressure or humidity. This climatic information is generally collected by a full service weather station and processed in one of a number of known complex formulas or equations to calculate the evapotranspiration value. The Hargreaves equation, set forth below, provides an accurate evapotranspiration formula which uses for its input data climatic information that is easily and inexpensively collectable at the specific site where the vegetation at issue is located. The Hargreaves equation is:

wherein:

ETₒ=0.00009×RA×(T° C.+17.8)×TD^{0.50}

ET₀=reference evapotranspiration (in inches of water per day); and
RA=extraterrestrial radiation expressed in equivalent evaporation (in inches of water per day); and further wherein:

$$\begin{matrix}T° C . = average daily temperature \\ = ( T max + T min ) / 2 ; and \\ TD = daily temperature differential \\ = T max - T min\end{matrix}$$

Hargreaves techniques have been improved upon by some conventional systems that collect daily high and low temperature data at the site of an irrigation controller. This temperature data is then processed, along with extraterrestrial radiation influenced equivalent evaporation data, in accordance with the Hargreaves equation, to determine a reference evapotranspiration value which represents an estimation of the current watering needs of a certain reference vegetation at the site. The reference evapotranspiration value is then adjusted by a local deviation factor specific to the site which affects evapotranspiration rates to generate an adjusted evapotranspiration value. More particularly, this local deviation factor accounts for any deviation between actual evapotranspiration or weather station climatic information driven evapotranspiration and the Hargreaves equation calculated evapotranspiration, and thus adjusts for localized errors in the application of the Hargreaves equation. The locally adjusted evapotranspiration value is then further adjusted, for example, to account for the type of vegetation at the site to generate a net evapotranspiration value representing an estimation of the current watering needs for the specific plants at that specific site. The net evapotranspiration value is then divided by a sprinkler head average precipitation rate to determine a run time for irrigation. The controller then irrigates the site for the duration of the determined run time necessary to satisfy the watering needs of the vegetation. Of course, the Hargreaves equation is only one technique that can be used to generate irrigation schedules.

Various conventional systems employ sensors to measure an amount of precipitation and/or to stop or prevent an irrigation cycle as a result of precipitation or freezing. One example sensor is described in U.S. Pat. No. 6,452,499, wherein a rain sensor includes a hygroscopic disk that expands when wet, and its expansion mechanically triggers a switch which in turn communicates a signal. For instance, precipitation may cause the disk to expand and trigger the switch, thereby causing an irrigation system to deactivate a watering cycle. However, there is a need in the art for a better precipitation sensor.

### SUMMARY

Systems and methods for irrigation are described below. In one example embodiment, a system includes a precipitation sensor having a hygroscopic material that is exposed to the environment so that precipitation impinges upon it when precipitation is present. The precipitation sensor also includes a first metal plate and a second metal plate placed on opposing sides of the hygroscopic material, thereby forming a capacitor having the hygroscopic material as a dielectric material.

Further in this example, the hygroscopic material has a variable permittivity that is affected by precipitation. For instance, the hygroscopic material may absorb rainwater, thereby increasing its permittivity. Similarly, as the hygroscopic material dries out, its permittivity may decrease. Various methods may be used to measure the electromagnetic behavior of the capacitor, specifically as its electromagnetic characteristics change as a result of exposure to precipitation.

Continuing with the example above, the electromagnetic characteristics of the capacitor act as a proxy for precipitation. Accordingly, precipitation may be measured by measuring a change in electromagnetic characteristics of the capacitor. In this embodiment, the precipitation sensor measures an electromagnetic characteristic of the capacitor and sends data indicative of the electromagnetic characteristic to a computer system. For instance, the precipitation sensor may output a signal indicative of substantial rainfall to instruct the irrigation system to interrupt or delay an irrigation cycle. In another embodiment, the sensor measures the electromagnetic characteristic within a range and with some precision The computer system then correlates the electromagnetic characteristic with a precipitation characteristic or amount, e.g., by using a lookup table or other suitable technique. The computer system then controls an irrigation system based at least in part on the information it receives from the precipitation sensor.

### BRIEF DESCRIPTION OF THE DRAWINGS

FIG. 1 illustrates an example precipitation sensor, in accordance with an embodiment of the disclosure.

FIG. 2 illustrates an simplified circuit diagram of a precipitation sensor employing a capacitive component, in accordance with an embodiment of the disclosure.

FIG. 3 illustrates an example circuit for measuring an electromagnetic characteristic of the capacitor of the precipitation sensor, in accordance with an embodiment of the disclosure.

FIG. 4 illustrates an example host device for controlling irrigation at a site, where the host device is in communication with the precipitation sensor of FIG. 1 in accordance with an embodiment of the disclosure.

FIG. 5 illustrates an example installation of an irrigation system that may employ a precipitation sensor such as that of FIG. 1, according to one embodiment.

FIG. 6 illustrates an example method performed by various components of the irrigation system, according to an embodiment of the disclosure.

FIG. 7 is another illustration of an example method performed by various components of the irrigation system, according to one embodiment.

### DETAILED DESCRIPTION

Example System Embodiments

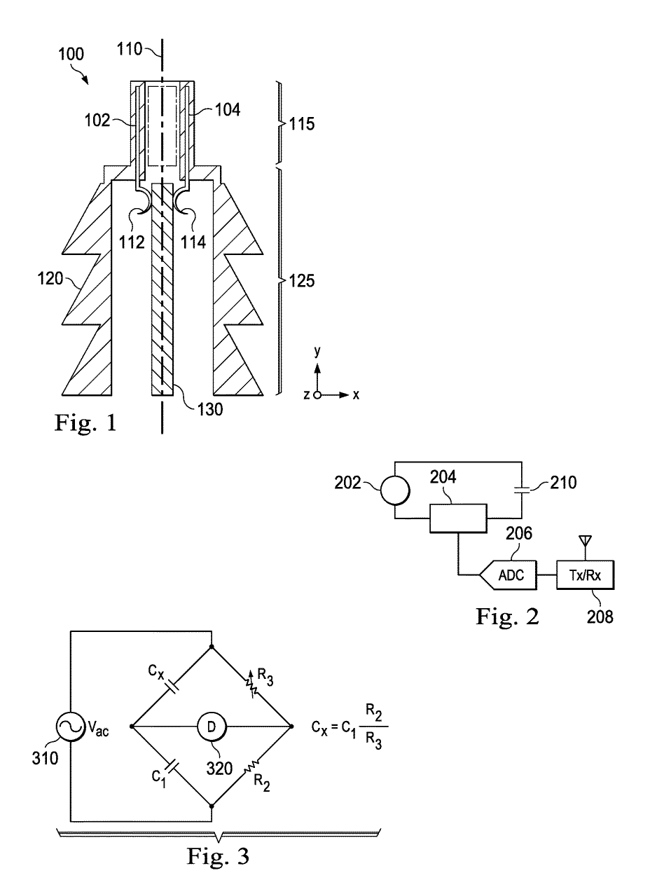

FIG. 1 is a cut away illustration of an example precipitation sensor 100, adapted according to one embodiment. In this example, the rain sensor concept takes advantage of the permittivity and dielectric properties of a medium 110 that becomes wet during rain. A rain event may be characterized by a certain amount of absorbed water and is configurable by the user. The relation between wet and dry can be determined by several means including change in capacitance or impedance, oscillator load-pull (changes to oscillator frequency with the change in load), and other RF techniques, as described more fully below.

Precipitation sensor 100 includes a housing 120, which may be constructed of polyvinyl chloride (PVC) or other suitable material that is relatively long-lasting when exposed to sunlight and weather. In the view of FIG. 1, the housing 120 is cut away along a vertical (y) dimension, thereby exposing the inside of the sensor assembly from top to bottom. For the purposes of this discussion, the rain sensor assembly includes a top portion 115 and a bottom portion 125, which are both formed by the housing 120.

The top portion 115 of the assembly is shown cut along its vertical dimension, and it may be formed as a cylinder, a rectangular prism, or other appropriate three-dimensional shape. Top portion 115 forms a cavity into which hygroscopic material 110 is disposed, and the cavity is open at its top, thereby exposing hygroscopic material 110 to the atmosphere and to precipitation when precipitation is present. Hygroscopic material 110 is a moisture-retaining material and also is a variable-permittivity material. When hygroscopic material 110 is exposed to precipitation, it absorbs water from the precipitation, and its permittivity value is affected by the amount of water that it absorbs. Specifically, when hygroscopic material 110 is relatively dry, it may have a low permittivity. By contrast, when hygroscopic material 110 is relatively wet, it may have a high permittivity. Furthermore, its permittivity may vary from low to high over a variety of values as it absorbs more water from precipitation. Accordingly, a value of the permittivity characteristic of the hygroscopic material 110 may provide an indication of an amount of precipitation. Similarly, a change in a value of the permittivity characteristic of hygroscopic material 110 may be used to make a yes/no decision about whether a particular amount of precipitation has been received.

Examples of material that may be used for the hygroscopic material 110 include ceramic and paper. Various embodiments may include any appropriate material for hygroscopic material 110, as long as that material provides a permittivity or other electromagnetic characteristic that varies with precipitation and can be practically measured.

Sensor contacts 102 and 104 in this example are metal plates that are formed into the housing 120 so that they are not exposed to weather or sunlight, thereby preventing corrosion. However, other embodiments may include any appropriate placement for sensor contacts 102 and 104. Sensor contact 102 includes a metal plate that extends along a vertical dimension of the top portion 115. Similarly, sensor contact 104 also includes a metal plate that extends along the vertical dimension of the top portion 115. Sensor contacts 102 and 104 are arranged so that they oppose each other and form a set of parallel or nearly parallel plates with hygroscopic material 110 disposed therebetween.

For instance, in an embodiment wherein top portion 115 is formed as a rectangular prism, sensor contacts 102 and 104 are spaced apart from each other in the horizontal (x) dimension and form substantially parallel planes in the z dimension. However, the scope of embodiments is not limited to the top portion 115 being shaped as a rectangular prism. Specifically, in another embodiment top portion 115 is formed as a cylinder, where from a top-down perspective sensor contacts 102 and 104 would appear substantially as semicircles. Continuing with the cylinder embodiment, sensor contacts 102 and 104 would similarly be placed to oppose each other across the horizontal dimension. Hygroscopic material 110 may be shaped to conform to a shape of the top portion 115 or use any appropriate shape.

In this manner, sensor contacts 102 and 104 form plates of a capacitor that has hygroscopic material 110 as a dielectric material placed between the plates of the capacitor. In one embodiment, the permittivity of hygroscopic material 110 may vary with an amount of absorbed precipitation. As explained in more detail below, the electromagnetic characteristics of the capacitor may be measured and used as an indicator of rainfall and may even be used to provide a relatively precise measure of rainfall in some instances.

Continuing with the example of FIG. 1, the sensor assembly includes lower portion 125. In the cut away example of FIG. 1, the housing 120 in the lower portion 125 has a sawtooth design on either side, which is a result of the lower portion 125 being designed as three concentric cone portions to allow precipitation to drain off of the housing and to provide a pleasing appearance to the eye. However, the scope of embodiments is not limited to any particular shape of the housing 120.

Sensor contacts 102 and 104 extend from the top portion 115 into the bottom portion 125, where they include leaf spring contacts 112 and 114. Leaf spring contacts 112 and 114 provide electrical communication from the capacitor of the top portion 115 to the printed circuit board (PCB) 130. Lower portion 125 includes a cavity into which PCB 130 is disposed to protect PCB 130 from sunlight and weather.

Although not shown in the cut away view of FIG. 1, PCB 130 includes a variety of electrical components to provide adequate sensing capability to the sensor 100. For instance, PCB 130 may have mounted thereon a power supply, a circuit to sense an electromagnetic characteristic of the capacitor, an analog to digital converter or other appropriate signal processing circuitry, and a transmitter or transceiver to transmit signals to a computer system. It should be noted, however, that the scope of embodiments is not limited to use of a printed circuit board, such as PCB 130, or leaf spring contacts, such as contacts 112 and 114. In fact, any appropriate electrical contact between the capacitor of top portion 115 and electrical components of bottom portion 125 may be used in various embodiments. Furthermore, the electrical components are not limited to being mounted on a printed circuit board, but may be arranged in any appropriate manner

FIG. 2 is a circuit diagram illustrating the circuit components of the sensor of FIG. 1, according to one embodiment. The diagram of FIG. 2 shows capacitor 210, which is formed by sensor contacts 102, 104 and hygroscopic material 110 in FIG. 1. The capacitor 210 is in electrical communication with the other components in FIG. 2 via the leaf spring contacts 112 and 114 of FIG. 1. Furthermore, the various components of FIG. 2 (other than capacitor 210) may be disposed upon PCB 130 of FIG. 1.

As noted above, the sensor includes capacitor 210. Capacitance (C) is based on distance between the plates (d), permittivity of the separating space (∈), and area of the opposing plates (A). For a truly parallel plate capacitor, the equation is C=∈A/d. However, various embodiments may include arrangements other than a truly parallel plate capacitor, such as in an instance where top portion 115 is formed as a cylinder. In those other embodiments, a person of ordinary skill in the art understands appropriate equations to model capacitance.

From the equation, with ∈1 being the permittivity of a dry material 110 filled with air and a second state where ∈2 is the permittivity of a damp or wet material 110, one can determine that the relative permittivity affects the measurement, especially if the relative permittivity is drastically different. With water having a much higher permittivity than air, the change between dry material 110 and that same material 110 being wet may be significant in some instances. Capacitance is the negative reactance part of impedance. It can be measured with charge time or attenuation.

The circuit diagram further includes a voltage source 202, which may be a direct current (DC) source or an alternating current (AC) source, depending on the application. In one example, voltage source 202 includes a 9 V or other appropriate battery in communication with a power converter to produce a 5 V AC voltage. In some examples, a frequency of the AC voltage may be adjustable. However, the scope of embodiments is not limited to those specific parameters. When supplied with an AC voltage, capacitor 210 has across its plates a varying voltage and current that is affected by an impedance of the capacitor, according to Ohm's Law. As noted above, capacitance is the negative reactance part of impedance, so that the capacitor 210 may be viewed as an impedance element and measured accordingly. Furthermore, although not shown here, a resistor may also be included with capacitor 210 to provide a known resistance component to the impedance of capacitor 210.

The relation between wet and dry can be determined by several techniques including change in capacitance or impedance, oscillator load-pull (changes to oscillator frequency with the change in load), and other RF schemes. When the hygroscopic material 110 is wet, the sensor is designed so that the impedance of the hygroscopic material 110 is measurably different than when hygroscopic material 110 is dry. To that end, the circuit of FIG. 2 also includes measuring circuit 204. Measuring circuit 204 may be designed as any appropriate circuit for measuring an electromagnetic characteristic of capacitor 210.

In one example, measuring circuit 204 includes a Wheatstone bridge arrangement configured to allow the measurement of the capacitance of capacitor 210. An example Wheatstone bridge 300 is shown in FIG. 3, where a voltage source 202 of FIG. 2 may be used as the AC voltage source 310. The capacitance value C1 is known, as is the resistance R2 and R3; the resistance R3 is variable. Cx is a capacitance value to be measured. When applied to the circuit of FIG. 2, capacitor 210 is arranged within the Wheatstone bridge 300 so that its capacitance is Cx and is measured. A control circuit (not shown) may be used to adjust the resistance R3 until detector 320 receives a null signal, at which point the following equation is true: Cx=C1*R2/R3. The technique of adjusting resistance R3 until detector 320 receives a null signal may be used repeatedly (e.g. periodically) to provide a plurality of capacitance measurements for capacitor 210.

Wheatstone bridge 300 allows for a relatively precise measurement of the capacitance of capacitor 210. Therefore, hygroscopic material 110 may be selected to provide a variable permittivity over a range corresponding to an expected range of precipitation amounts. The variable permittivity affects the capacitance of capacitor 210, and in this way measurements using the Wheatstone bridge 300 may provide an indication as to the permittivity of hygroscopic material 210, from which may be derived a corresponding precipitation amount.

Continuing with the example, measurement circuit 204 may be configured as a Wheatstone bridge, where circuit 206 may actually control and measure the performance of Wheatstone bridge 300 to output a digital signal indicative of the capacitance of capacitor 210. In one example, circuit 206 includes among other things an analog to digital converter so as to convert an analog phenomenon into a digital signal representative of the capacitance of capacitor 210. Circuit 206 then passes the digital signal to transceiver circuit 208. Transceiver circuit 208 transmits that digital signal, or a digital signal derived from that digital signal, to a computer system. As described below in more detail, the computer system may then use the digital signal to determine an amount of precipitation and generate an irrigation schedule based at least in part thereon. For instance, the computer system may include a lookup table that correlates digital signal values with amounts of precipitation. The computer system, upon receiving a signal from transceiver circuit 208, may consult the lookup table to determine an amount of precipitation that has been detected. The lookup table may be preprogrammed during manufacture, may be adjusted by a user, and may be recalibrated from time to time as desired.

The above example using Wheatstone bridge 300 illustrates a mode of operation in which the precipitation sensor 100 of FIG. 1 may be used in conjunction with a computing device to more precisely measure precipitation over a range, where a multitude of values within that range may be used to express precipitation amounts (e.g., rainfall in tenths of an inch). Ranges of precipitation may also be measured using a voltage or current controlled oscillator at circuit 204, where increased capacitance (and thus increased impedance) causes a frequency of the oscillator to either decrease or increase. Frequency of the oscillator can then be used to measure a capacitance of capacitor 210. The scope of embodiments is not limited to any particular measuring circuit for ranges of precipitation.

However, another mode of operation can be used to provide a simple yes/no indication of whether precipitation has reached a particular amount. This other mode of operation can find use for precipitation sensor 100 as a rain sensor in conjunction with an irrigation controller, where a measurable amount of precipitation is registered as a YES signal that indicates to the controller to interrupt an irrigation cycle or to delay an irrigation cycle. Some conventional irrigation systems use rain sensors to shut off sprinklers during a rain event so as not to waste water. In the second mode of operation, precipitation sensor 100 may be used as a rain sensor to provide a YES/NO indication of substantial rainfall.

Looking at FIG. 2 again, measuring circuit 204 may be an amplifier, and attenuator, or other appropriate circuit with an output indicative of a current or voltage amplitude. Since capacitance is a reactive part of the impedance, and since increasing impedance typically reduces current, measuring circuit 204 may be configured to measure amplitude changes of current. Additionally, capacitance is generally expected to cause a phase shift of the voltage and current waveforms at measuring circuit 204, and those phase shifts may be measured by circuit 204 to characterize the capacitance of capacitor 210.

In one example, substantial precipitation may be correlated with a particular capacitance, which itself may be correlated with a particular current amplitude or waveform phase shift. Accordingly, measuring circuit 204 in conjunction with circuit 206 measures the capacitance of capacitor 210 and outputs a digital signal providing a YES or a NO as to substantial rainfall. Of course, what counts as a substantial rainfall may be preset during manufacture or may be adjustable by a user. In some embodiments, the precipitation sensor may be recalibrated from time to time if appropriate. The digital signal is passed to transceiver 208, which sends an indication of the signal to a computer or irrigation controller. The signal can then be used, for example, to interrupt or delay an irrigation cycle in response to detecting substantial rainfall.

Therefore, as discussed above, precipitation sensor 100 of FIG. 1 may be used at least in two different modes. In a first mode, precipitation sensor 100 may be used with a more precise measuring circuit to facilitate the measurement of precipitation over a range of values (e.g. tenths of an inch of rain). In a second mode, precipitation sensor 100 may be used with the measuring circuit mentioned above or even a less precise measuring circuit to provide a YES or NO indicative of whether there is a substantial amount of precipitation. The first mode may be used, for example, to provide relatively precise precipitation measurements for use in a Hargreaves algorithm. The second mode may be used, for example, to interrupt or delay an irrigation cycle in response to detected rainfall.

Various embodiments may provide one or more advantages over conventional systems. For instance, the embodiment discussed above with respect to FIGS. 1 and 2 is electrical in nature and does not include moving parts, such as mechanical switches. Accordingly, the embodiment of FIGS. 1 and 2 may provide durability. Furthermore, embodiments including a Wheatstone bridge or other precision measuring circuit may provide for greater granularity of values that can be measured, as opposed to a mechanical switch which provides only a single value.

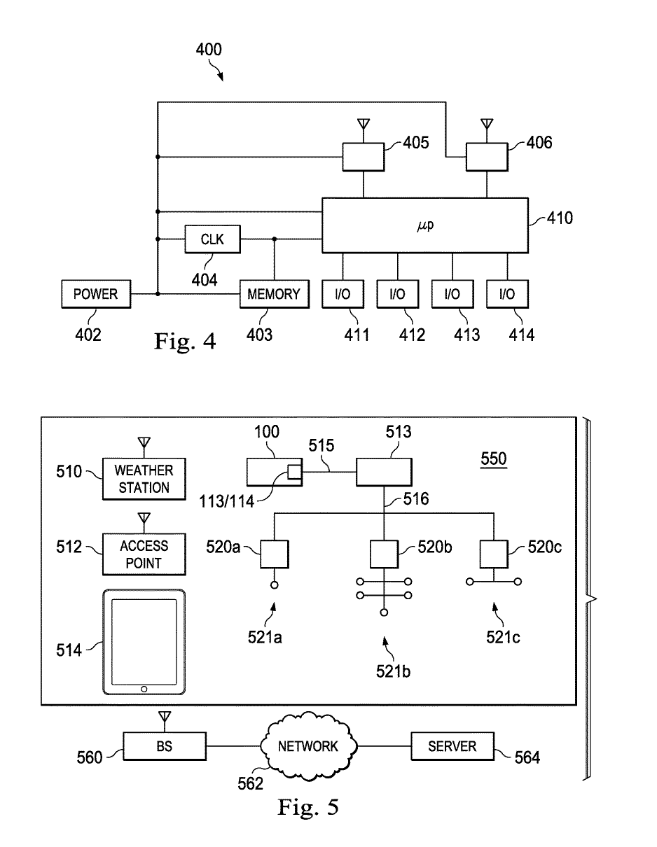

The discussion that follows provides an example of a system into which precipitation sensor 100 may be adapted. FIG. 4 is an illustration of an example computer system, or host device, which includes logic therein to generate irrigation schedules and to communicate with the precipitation sensor 100. FIG. 5 is an illustration of how precipitation sensor 100 and other components of an irrigation system may be installed at a particular site. As discussed further in more detail below, precipitation sensor 100 may be a standalone sensor or may be integrated with a more comprehensive weather station (e.g., weather station 510 of FIG. 5), but in either case precipitation sensor 100 provides input to an irrigation system. FIGS. 4 and 5 discuss a particular embodiment wherein a retrofit host device controls an existing irrigation controller. In other embodiments, sensor 100 may be in communication directly with an irrigation controller rather than through a retrofit host device.

FIG. 4 is an architectural diagram illustrating an example host device 400, according to one embodiment. In one example, host device 400 is a computer system that is in communication with a precipitation sensor, such as sensor 100 of FIG. 1. Host device 400 receives information from a precipitation sensor and uses that information to generate irrigation schedules, interrupted irrigation cycle, and/or delay an irrigation cycle.

The host device 400 includes microprocessor (CPU) 410 a memory 403 including a programmable read only memory (ROM/PROM) portion and a random access memory (RAM) portion. The memory 403 provides a non-volatile storage location for the programming code of the host device along with certain data necessary for execution of the code. The memory 403 provides a volatile storage location for certain (variable/temporary) data generated during execution of the programming code. The microprocessor 410 communicates with the memory 403 in a conventional manner utilizing an address bus and a data bus (not shown). It will be understood that the memory 403 may be incorporated integrally within, or provided separate and apart from, the microprocessor 410.

Host device 400 also includes wireless communication device 405 for communicating with a weather station, where an example weather station is described in more detail with respect to FIG. 5. In one example, a precipitation sensor, such as that described above with respect to FIGS. 1-3, may be integrated with a weather station or may be a stand-alone sensor. In this example, wireless communication device 405 includes a 900 MHz transceiver with an antenna, where 900 MHz is desirable for many on-site deployments because of the relative quality of the signal compared with other parts of the radio spectrum. However, the scope of embodiments is not limited to use of 900 MHz only, as other examples may use for instance 2.4 GHz or other available bands.

Wireless communication device 405 provides an interface with the weather station, where the weather station provides weather data to be stored in memory 403 and processed by microprocessor 410. In one example, in response to instruction by microprocessor 410, wireless device 405 polls the weather station and in response receives weather data transmitted from the weather station. Wireless device 405 is a communication device which passes the received data to microprocessor 410, which then stores the data to memory 403 for later use.

One type of weather data that may be received from the weather station includes temperature data. In accordance with the operation of the programming code, temperature data collected by the weather station is passed through the wireless device 405 at the request of the microprocessor 410 and stored by memory 403. The temperature data is then subsequently retrieved from the memory 403 by microprocessor 410 and processed by the microprocessor 410 in accordance with the execution of the programming code to determine an amount of water to be applied to replace water lost through the effects of evapotranspiration.

Host device 400 also includes wireless device 406, which in this example provides for data communication over any of a plurality of different protocols, including 3G and 4G cellular data, Wi-Fi (IEEE 802.11), and the like. In one example, wireless device 406 is a cellular data transceiver, and it communicates with a cellular base station (not shown), which provides a connection to a central server (also not shown). Additionally or alternatively, wireless device 406 may also include a Wi-Fi transceiver for communicating with a local access point, which provides an Internet connection to the central server. In any event, host device 400 includes a connection to a central server that provides data management.

Input data may, in some instances, be stored in the memory 403 by microprocessor 410. The kinds of data input into the host device 400 may include, for example: a preferred time of day when irrigation is to be effectuated; a preferred day (or days) of the week when irrigation is to be effectuated; an identification of soil type for the irrigated area; an identification of the vegetation type (crop coefficient); site latitude; sprinkler flow rates; and, a local irrigation adjustment factor. A user interface may further be utilized to initiate certain host device 400 activities (such as, for example, an irrigation operation, a self test, or the like) without regard to the current state of programming code execution.

Host device 400 further includes input output port 411, which may be connected by wire to one or more sensors that affect irrigation. An example of such a sensor is precipitation sensor 100 of FIG. 1. When the precipitation sensor 100 detects moisture, this is indicative of a rainfall event. During such a rainfall event, a signal (e.g., a YES or NO signal) is passed from the transceiver or transmitter of the precipitation sensor 100 to the port 411, and the microprocessor 410 responds thereto by temporarily suppressing controller actuation to sprinkle. In another example, precipitation sensor 100 is used in a more precise manner to provide an indication of an amount of rainfall over a range (e.g., tenths of an inch), and precipitation sensor 100 passes digital data to the port 411. In response to receiving the signal, the microprocessor 410 adjusts (e.g., reduces) its programming code calculated irrigation amount of water which needs to be applied to replace water lost through the effects of evapotranspiration. Another example of such a sensor is a freeze sensor, which detects a freeze and prevents host device 410 from causing a controller to actuate sprinkler valves. Additionally or alternatively, such sensors may be integrated with the weather station, wherein such sensor data would be received by host device 410 via wireless device 405.

A serial communications port 412 is connected to (or is incorporated in) the microprocessor 410 to support communications between the host device 400 and external devices such as a personal/laptop computer (not shown). Through this serial port 412, the programming code (and data) stored in the memory 403 may be updated and data may be extracted from or downloaded to the memory 403. As an example, a table of extraterrestrial radiation influenced equivalent evaporation data for each month/day of the year at a plurality of latitudes may be downloaded into the memory 403 through the serial port 412. The serial port 412 further allows a technician to have access to the microprocessor 410 for the purpose of performing diagnostic and maintenance operations on the host device 400.

A time of day clock 404 is connected to the microprocessor 410 through the address bus and data bus. This clock 404 maintains a non-volatile record of month, day, hour of the day, minutes of the hour and seconds of the minute. The clock 404 generates an output time data that is monitored by the microprocessor 410 with the time data driving certain operations in accordance with the programming code. These operations include: reading and storing temperature data; initiating and stopping irrigation activities; and, performing certain irrigation related calculations.

Input and output ports 413 and 414 are in communication with microprocessor 410, and allow host device 400 to send signals to an external irrigation controller (not shown) to cause that external irrigation controller to actuate irrigation valves. In this example, input output port 413 is a generalized port that may include any appropriate physical connector. Various embodiments described herein may be used as a retrofit solution, allowing host device 400 to send signals to existing external irrigation controllers. Conventional external irrigation controllers, available from a variety of different suppliers, may include any of a multitude of proprietary physical interfaces for receiving remote control signals. For example, one conventional external irrigation controller supplier may implement a three-pronged wire input, whereas another supplier of conventional irrigation controllers may implement a four-pronged wire input. In any event, it is understood that host device 400 may be included with a plurality of adapters, for interfacing input output port 413 with a plurality of different proprietary remote control inputs of different irrigation controllers.

Therefore, the physical configuration of input output port 413 may be dependent upon the minimal number of output signals needed to service a remote control input having a maximum number of input signals. Input output port 414 in this example conforms to the well-known Modbus protocol. Microprocessor 410 may use either or both of ports 413 and 414 to remotely control an external irrigation controller.

It is also understood that suppliers of different irrigation controllers may use different remote control signals to allow an external device (such as host device 400) to control the irrigation controller to open and close appropriate valves at appropriate times. Accordingly, memory 403 may store instructions allowing it to communicate appropriately with any of a number of irrigation controllers. For instance, if one conventional irrigation controller uses a first communication protocol for remote control, and if another conventional irrigation controller uses a second communication protocol for remote control, memory 403 may be pre-programmed to conform to those protocols, thereby allowing host device 400 to cause either of those controllers to actuate irrigation valves appropriately.

Power controller 402 receives power from a source (e.g., 120 V AC) and converts it into power that is appropriate for microprocessor 410 and wireless devices 405 at 406. Microprocessor 410 may be implemented using any appropriate logic circuits. For example, microprocessor 410 may include a general purpose Central Processing Unit (CPU), a Digital Signal Processor (DSP), an Application Specific Integrated Circuit (ASIC), a Field Programmable Gate Array (FPGA), and or the like that is operable to execute computer code to perform the actions described herein. For instance, the computer-executable code may be stored to memory 403, where microprocessor 410 reads that code and executes it upon start up. As a result of executing the code, the microprocessor 410 generates irrigation schedules and provides remote control signals to cause a controller to actuate irrigation valves.

In accordance with the execution of the programming code, the microprocessor 410 outputs irrigation control signals through the I/O interfaces 413 and or 414 to control the actuation of irrigation control valves (not shown). These control valves operate to either allow or block the passage of water to one or more sprinkler heads. In one example, each control valve is associated with a particular sprinkler or irrigation zone, where a given site may include one or more zones that are independently controlled and have their own respective irrigation schedules. The length of time each irrigation control valve (i.e., zone) is actuated to allow the passage of water is calculated by the microprocessor 410 in accordance with the execution of the programming code.

The daily temperature data of importance to the Hargreaves equation (high, low and differential) is calculated by the microprocessor 410 from the temperature information collected by the weather station and stored in the memory 403. As noted above, precipitation sensor 100 may be integrated with a weather station. In some embodiments, precipitation sensor 100 may include a thermometer and relay temperature data via its transceiver to the host device 400. The latitude of the controller site is input by the user into the memory 403 using, for example, a user interface that communicates through a central server and through wireless device 405. Using this latitude data, date (month or day) sensitive equivalent evaporation data of importance to the Hargreaves equation is determined from a latitude based extraterrestrial radiation table stored in the memory 403. The microcontroller 410 then determines a reference evapotranspiration value from the Hargreaves equation (and is perhaps summed over a plurality of days since a last irrigation) at instances when an irrigation event occurs.

Microcontroller 410 then adjusts the reference evapotranspiration value by a local adjustment coefficient to account for presumed average variation between the Hargreaves equation calculated watering needs and either (1) actual watering needs or (2) Penman-Monteith, modified Penmans or other similar evapotranspiration equation calculated watering needs. The local adjustment coefficient is estimated and input by the user or by the central server and saved to the memory 403. The value of this local adjustment coefficient is affected by factors such as site altitude, site shade conditions, local weather patterns and characteristics (humidity, aridity and the like), drainage and topology.

The microcontroller 410 then adjusts the locally adjusted evapotranspiration value by the crop coefficient to account for the specific type of vegetation being sprinkled. The crop coefficient is input by the user into the memory 403 using, for instance, a user interface in communication with a central server. Next, the microcontroller 410 further adjusts the crop adjusted evapotranspiration value to account for any measured rainfall since the last irrigation. The microcontroller then divides the rainfall adjusted evapotranspiration value by the average precipitation rate for the sprinkler heads to determine run time for the actuation of each irrigation control valve. This average precipitation rate information is input by the user into the memory 403 by, for instance, the user interface in communication with a central server. The host device 400 then actuates each irrigation control valve by sending remote control signals to the irrigation controller, thereby causing the irrigation controller to open and close the valves as appropriate according to the specified run time.

FIG. 5 is a block diagram illustration of a deployed system, according to one embodiment. The deployed system shows host device 400 communicatively connected to irrigation controller 513 by input output ports 413/414. In this example, host device 400 may be embodied using a Printed Circuit Board (PCB) having the electronic components shown in FIG. 4 mounted thereon, with the PCB disposed within a ruggedized housing. The scope of embodiments is not limited to any specific housing, although a relatively rigid housing made of polyvinyl chloride (PVC) or other suitable plastic may be appropriate in some installations. Input output ports 413/414 are exposed externally to the housing, facilitating a wired connection 515 between host device 400 and controller 513.

Similarly to host device 400, irrigation controller 513 may also be implemented using a PCB for internal electronics disposed within a ruggedized housing. The scope of embodiments is not limited to any specific housing for the irrigation controller 513, although in many instances a housing similar to that used for host device 400 may be appropriate. It is noted that host device 400 and irrigation controller 513 are separate devices and embodied in separate housings. Specifically, in this embodiment, host device 400 is a retrofit device that is in communication with a remote control input port (not shown) of irrigation controller 513 via wired interface 515, thereby allowing host device 400 to send remote control signals to irrigation controller 513. In this manner, host device 400 provides control for the irrigation system using previously-installed irrigation controller 513.

Further in this example, irrigation controller 513 is installed at site 550, perhaps mounted by brackets to a wall or using other suitable mounting technique. Irrigation controller 513 has wired interface 516 to irrigation valves 520. During operation, irrigation controller 513 provides electrical signals to a selected one of the irrigation valves 520, thereby activating that valve to cause water to erupt from its corresponding sprinkler heads 521.

Continuing with the example, each of the irrigation valves 520 corresponds to an irrigation zone of site 550. Host device 400 has a generated irrigation schedule, which specifies a watering time and watering duration for each of the three zones of site 550. For purposes of this illustration, assume that valve 520A corresponds to Zone 1, irrigation valves 520B corresponds to Zone 2, and irrigation valve 520C corresponds to Zone 3. Host device 400 sends remote control signals to irrigation controller 513, thereby causing irrigation controller 513 to actuate valves 520 zone-by-zone according to the irrigation schedule. Host device 400 executes program code to cause it to read a generated irrigation schedule from its memory and to apply that schedule to the zones.

In the example of FIG. 2, host device 400 sends remote control signals to irrigation controller 513 to cause irrigation controller 513 to apply electrical signals to open and close irrigation valve 520A at appropriate times and for appropriate lengths of time, according to the irrigation schedule. Similarly, host device 400 causes irrigation controller 513 to apply electrical signals to open and close irrigation valve 520B according to the irrigation schedule; host device 400 also causes irrigation controller 513 to apply electrical signals to open and close irrigation valve 520C according to the irrigation schedule as well. In other words, host device 400 controls irrigation controller 513 to implement the irrigation schedule zone-by-zone so that each zone is treated independently.

The example of FIG. 2 shows only three zones at site 550, but the scope of embodiments is not limited to only three zones. The system shown in FIG. 2 may be scaled to any appropriate number of zones for site 550. Additionally or alternatively, the system shown in FIG. 2 may control individual sprinkler heads 521, assuming that such individual sprinkler heads may be individually actuated by electrical signals from irrigation controller 513.

Further at site 550, there is weather station 510, which operates as described above. Consistent with the disclosure above, some embodiments may include integrating the precipitation sensor 100 of FIG. 1 with the weather station 510 of FIG. 5. Alternatively, precipitation sensor 100 of FIG. 1 may be a stand-alone sensor in addition to weather station 510 and communicating independently with host device 400. Weather station 510 (and/or a standalone precipitation sensor) may be mounted, for instance, in an area where it may receive sunlight, wind, and precipitation so that it provides accurate weather data. As noted above, weather station 510 communicates wirelessly with host device 400 to pass weather data from weather station 510 for processing and storage at host device 400. For instance, some embodiments may use a 900 MHz wireless connection for communications between weather station 510 and host device 400. While weather station 510 is shown communicating wirelessly, it is within the scope of embodiments that a wired connection may be made in addition to or instead of a wireless connection (this is also true for a standalone precipitation sensor). It is noted that weather station 510 is included at the same site as host device 400 and irrigation controller 513. Thus, host device 400 generates an irrigation schedule using weather data gathered on-site and performs the processing to generate the irrigation schedule on-site.

Site 550 also includes wireless access point 512, which may include a IEEE 802.11 (Wi-Fi) access point or other appropriate access point capable of communicating wirelessly with weather station 510, host device 400, and mobile computing device 514. For example, a wireless access point 512 may provide a wireless Internet connection available for use by other wireless communicating devices and may also act as a communications switch, routing communications between wireless communicating devices. In one example method of communication, host device 400 communicates wirelessly with weather station 510 using access point 512 as a communications switch. In another example method of communication, host device 400 communicates with a central server 564 using a wireless Internet connection provided by wireless access point 512.

In some embodiments, the algorithm used to calculate irrigation schedules is affected by boundary conditions of site 550. Examples of boundary conditions include, e.g., soil type, sprinkler head type, vegetation type, latitude of site, and/or any other relevant factor. A technique to enter such information into the memory at host device 400 includes using a graphical user interface application at mobile computing device 514. In such a technique, a user may open the application operating on mobile device 514 and access an interface configured to receive information regarding boundary conditions. The user enters information into the interface, thereby causing the information to be sent to central server 564 via wireless access point 512 and network 562 (e.g., the Internet).

Returning to FIG. 5, base station 560 is located away from site 550. Base station 560 includes a cellular data base station, such as a 3G or 4G base station, or other appropriate base station. The scope of embodiments is not limited to any particular communications technology for base station 560, so other data transmissions protocols now known or later developed, including 5G wireless access, may be supported by base station 560. In the embodiment of FIG. 2, base station 560 is used to transmit data between host device 400 and central server 564. Thus, while the example above provides an illustration of Internet access using wireless access point 512, the embodiment further provides for data communications via base station 560. An example method of use includes a user entering boundary conditions using mobile computing device 514, where its boundary conditions are received through network 562 at server 564. Central server 564 then sends that data to host device 400 using a cellular data protocol, such as 3G or 4G, as facilitated by a wireless communication device (such as transceiver 405 of FIG. 4) at host device 400.

A mobile application executed by mobile computing device 514 may be used to control various functionality of host device 400. A user can enter boundary conditions (e.g., soil type, vegetation type) using the application, where its boundary conditions are downloaded to host device 400 using either wireless access point 512 or base station 560. Various embodiments also include additional control functionality, such as allowing a human user to test sprinklers and valves in various zones, to access diagnostic information, or to access historic weather data using the application as well. Such additional functionality may be provided by central server 564, which stores diagnostic information and historic weather and historic operational data. In some embodiments, central server 564 includes one or more databases of operational and weather data for a variety of sites, including site 550, and making that data available to users of applications at a variety of different mobile devices and at a variety of different sites.

Further in this embodiment, host device 400 reports to central server 564 every day or at other appropriate time periods so that central server 564 includes a comprehensive record of operational and weather data at site 550.

Site 550 of FIG. 5 may include any of a variety of localized areas. An example of a site includes a residential address, an elementary school campus encompassing the city block, a commercial facility having a shopping center or a big-box store. Larger sites, such as college campuses or multiple-acre commercial establishments may be divided into smaller sites and may include multiple weather stations and or multiple host devices. In some examples, a site is under control of a single manager responsible for irrigation, in contrast to a large residential area with multiple homeowners or a commercial district with a variety of commercial owners and tenants. In many instances, a site is smaller in land area than a comparable area covered by a commercial weather service having a small number of weather stations in a given square mile.

Example Method Embodiments

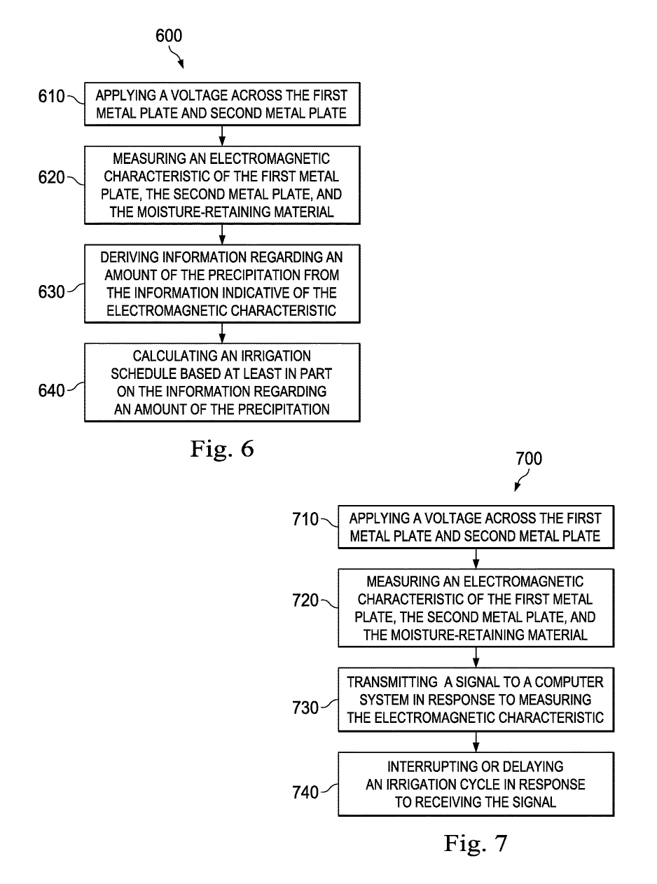

A flow diagram of an example method 600 of operating an irrigation system, such as the irrigation system of FIG. 5, is illustrated in FIG. 6. In one example, some actions of method 600 are performed by a microprocessor of a host device, which executes computer program code to generate and implement irrigation schedules at a site, while other actions of method 600 are performed by circuitry at a precipitation sensor. The microprocessor or other logic circuit performs such actions by reading computer program code from a computer-readable medium executing that code.

At action 610, the precipitation sensor applies a voltage across a first metal plate and a second metal plate. An example is shown with respect to FIG. 1, where sensor contacts 102 and 104 form a capacitor with hygroscopic material 110 acting as a dielectric material between the contacts 102, 104. A power supply at the precipitation sensor may apply a voltage, such as an AC voltage, across the metal plates, thereby producing a current within a circuit that includes the capacitor device.

At action 620, a circuit at the precipitation sensor measures an electromagnetic characteristic of the first and second metal plates and the moisture-retaining medium. One example is explained with respect to FIG. 3, where a circuit at the precipitation sensor employs a Wheatstone bridge to measure a capacitance value of the capacitor that is formed by the metal plates and moisture-retaining material. Other embodiments may include other kinds of measurement, such as a circuit that can measure a voltage amplitude or a current amplitude affected by a change in impedance of the capacitor and/or an oscillator that is frequency modulated by a change in voltage or current caused by a change in impedance of the capacitor. In fact, the scope of embodiments includes any appropriate technique to measure an electromagnetic characteristic of the capacitor.

Furthermore, action 620 may also include generating a digital signal indicative of the measured electromagnetic characteristic. Going back to the Wheatstone bridge example, a circuit at the precipitation sensor may generate a digital signal indicative of a measured capacitance or impedance. Similarly, a circuit measuring an amplitude of a voltage or current may output a digital signal indicative of the amplitude. Also, a circuit measuring a frequency of oscillation may output a digital signal indicative of the frequency.

Electromagnetic characteristics of the capacitor describe the behavior of the capacitor, and in the various embodiments, the capacitor is designed such that a moisture level of the hygroscopic or moisture-retaining material varies a permittivity of the capacitor. The electromagnetic characteristics of the capacitor, therefore, correlate with precipitation values. Measuring the electromagnetic behavior of the circuit that includes the capacitor thus may provide insights as to precipitation values.

At action 630, a logic circuit derives information regarding an amount of precipitation from the information indicative of the electromagnetic characteristic. Action 630 may be performed by a logic circuit at the precipitation sensor or at a processor in a computer system (e.g., host device 400) that communicates with the precipitation sensor. The scope of embodiments is not limited to any arrangement of logic circuits. Action 630 may include, for example, receiving a digital signal indicative of the electromagnetic characteristic and comparing it to entries in a table of values, where the table of values links digital signal values to indications of precipitation. Such table may be pre-stored in the precipitation sensor or computer system at manufacture and may be updated or recalibrated by a user or technician in the field as appropriate.

Additionally or alternatively, action 630 may include use of an algorithm to determine precipitation rather than a lookup table. For instance, one or more equations may be programmed into the precipitation sensor or computer system, where those equations provide an indication of precipitation when a digital signal indicative of the electromagnetic characteristic is input into those equations. Any appropriate technique for deriving precipitation information from the electromagnetic characteristic may be used in the various embodiments.

At action 640, the irrigation system calculates an irrigation schedule based at least in part on the information regarding an amount of precipitation. For instance, it was described above that the Hargreaves equation may be used by an irrigation system to generate an irrigation schedule, where amounts of precipitation are an input to the Hargreaves equation. In various embodiments, the precipitation amount of action 630 may be input into a Hargreaves equation or other algorithm to calculate an irrigation schedule.

Some embodiments may collapse actions 630 and 640 into a single action, for example, by algorithmically defining a Hargreaves equation or other equation to accept as inputs digital signals measuring the electromagnetic characteristic of the circuit that includes the capacitor. Such embodiments assume that a relationship between the electromagnetic characteristic and precipitation values is known beforehand, and that relationship is built into the Hargreaves equation or other equation.

The scope of embodiments is not limited to the specific method shown in FIG. 6. Other embodiments may add, omit, rearrange, or modify one or more actions. For instance, some embodiments may include performing actions 610-640 periodically or at scheduled times during operation of the irrigation system. Additionally, communication between the precipitation sensor and the computer system may be wired or wireless.

A flow diagram of an example method 700 of operating a host device is illustrated in FIG. 7. Some of the actions of FIG. 7 are performed by a logic circuit of a precipitation sensor, and other actions of FIG. 7 are performed by a logic circuit of a host device (e.g., host device 400). The microprocessor or other logic circuit performs such actions by reading computer program code from a computer-readable medium executing that code.

Method 600 of FIG. 6 describes an embodiment where a precipitation sensor can output a range of values indicative of a range of precipitation (e.g., tenths of an inch). Information from the precipitation sensor can then be used to calculate an irrigation schedule. By contrast, method 700 of FIG. 7 describes an embodiment in which a precipitation sensor outputs a YES or NO signal in response to detecting precipitation.

Method 700 of FIG. 7 is similar to method 600 of FIG. 6, insofar as actions 710-720 are the same as actions 610-620. Accordingly, the description of FIG. 7 proceeds to describing action 730.

At action 730, the precipitation sensor transmits a signal to a computer system, such as host computer 400, in response to measuring the electromagnetic characteristic. Communication may be wired or wireless. Action 730 may include determining whether precipitation has reached a particular amounts. For instance, the precipitation sensor may include a logic circuit that transmits a signal when a particular value for the electromagnetic characteristic is reached, where that particular value of the electromagnetic characteristic may be correlated with a particular value of precipitation. In some examples, the particular value of the electromagnetic characteristic may be pre-programmed into memory at the precipitation sensor. Upon recognizing that the particular value for the electromagnetic characteristic is reached, the precipitation sensor transmits the signal to the computer system. Action 730 may also include transmitting the signal after being polled by a controller, so that communication may be push-based or pull-based.

In one example, substantial rainfall is characterized as one-fourth of an inch of rain. The precipitation sensor is preprogrammed so that an electromagnetic characteristic of the capacitor corresponding to water absorption expected at one-fourth of an inch of rain triggers the precipitation sensor to send the signal. Of course, that is an example, and the scope of embodiments includes defining the particular electromagnetic characteristic value and precipitation value using any appropriate criteria.

At action 740, the irrigation system interrupts or delays and irrigation cycle in response to receiving the signal. In one example, the irrigation system is performing an irrigation cycle by irrigating at least one zone at a site. Upon receiving the transmitted signal of action 730, logic circuits at the host device or irrigation controller interrupts the irrigation cycle. Action 740 may also include delaying an irrigation cycle in response to receiving the signal. For instance, upon receiving the signal the host device are irrigation controller may set a flag in memory to indicate that any further irrigation cycle should not occur less than 48 hours from the time that the signal is received from the precipitation sensor. Of course, that is an example, and any appropriate time to delay an irrigation cycle may be used in various embodiments.

The scope of embodiments is not limited to the method 700 of FIG. 7. Other embodiments may add, omit, rearrange, or modify one or more actions. For instance, various embodiments may perform method 700 periodically or multiple times over a period of time as appropriate for irrigating a particular area.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A system comprising:
a computer system; and
a precipitation sensor having:
a first conductive plate;
a second conductive plate;
a moisture-retaining medium disposed between the first conductive plate and the second conductive plate;
a voltage source configured to create a voltage difference between the first conductive plate and a second conductive plate;
an electromagnetic sensor configured to measure an electromagnetic behavior of the first conductive plate, second conductive plate, and moisture-retaining medium; and
a first communication interface configured to transmit information indicative of the electromagnetic behavior, as measured by the electromagnetic sensor, to the computer system;
the computer system having:
a second communication interface configured for communicating with the precipitation sensor to receive the information indicative of the electromagnetic behavior;
a computer processor configured for receiving information indicative of the electromagnetic behavior and controlling irrigation in response thereto.

2. The system of claim 1, wherein the computer processor is further configured to generate an irrigation schedule based at least in part on the information indicative of the electromagnetic behavior and boundary conditions for the site.

3. The system of claim 1, wherein the computer processor is further configured to interrupt or delay an irrigation cycle in response to receiving the information indicative of the electromagnetic behavior.

4. The system of claim 1, wherein the precipitation sensor and the computer system are installed at a same site, and further wherein the site comprises commercial real estate having a single address.

5. The system of claim 1, wherein the precipitation sensor and the computer system are installed at a same site, and further wherein the computer system has a third communication interface configured for communicating with an irrigation controller at the site, the computer processor configured to control irrigation valves at the site via the third communication interface, and according to the irrigation schedule.

6. The system of claim 1, wherein the electromagnetic sensor comprises a Wheatstone bridge configured to measure a capacitance of the first conductive plate, the second conductive plate, and the moisture retaining medium.

7. The system of claim 1, wherein the electromagnetic sensor comprises an oscillator in communication with the first conductive plate and a second conductive plate, wherein a frequency of the oscillator is affected by a capacitance of the first conductive plate, second conductive plate, and the moisture-retaining medium.

8. The system of claim 1, wherein the voltage source comprises and alternating current (AC) voltage source.

9. The system of claim 1, wherein the voltage source, the electromagnetic sensor, and the first communication interface are mounted on a Printed Circuit Board (PCB) disposed with in a housing of the precipitation sensor.

10. The system of claim 1, wherein the information indicative of the electromagnetic behavior comprises a digital signal indicative of a capacitance of the first metal plate, the second metal plate, and the moisture-retaining medium.

11. A method performed by an irrigation system, the irrigation system having a sensor that includes a first metal plate and a second metal plate with a moisture-retaining material placed therebetween to form a capacitive device, the moisture-retaining material being exposed to precipitation, the method comprising:
applying a voltage across the first metal plate and second metal plate;
measuring an electromagnetic characteristic of the first metal plate, the second metal plate, and the moisture-retaining material;
deriving information regarding an amount of the precipitation from the information indicative of the electromagnetic characteristic; and
calculating an irrigation schedule based at least in part on the information regarding an amount of the precipitation.

12. The method of claim 11, further comprising:
transmitting information indicative of the electromagnetic characteristic to an irrigation system, which derives the information regarding an amount of the precipitation and calculates the irrigation schedule.

13. The method of claim 11, wherein measuring the electromagnetic characteristic comprises:
treating the first metal plate, the second metal plate, and the moisture-retaining material as a capacitive device with an unknown capacitance in a Wheatstone bridge.

14. The method of claim 11, wherein measuring the electromagnetic characteristic comprises:
measuring a change in a frequency of oscillation of an oscillator in communication with the first metal plate, the second metal plate, and the moisture retaining material.

15. The method of claim 11, wherein deriving information regarding an amount of the precipitation from the information indicative of the electromagnetic characteristic comprises:
comparing the information indicative of the electromagnetic characteristic to a plurality of entries in a stored lookup table, matching the information indicative of the electromagnetic characteristic to a corresponding entry in the store lookup table, and using a value in the corresponding entry as an indication of the amount of precipitation.

16. The method of claim 11, wherein the voltage comprises an alternating current (AC) voltage with a sinusoidal waveform.

17. A precipitation sensor comprising:
an outer housing formed of an insulating material, the outer housing having a top portion and forming a first cavity, an inside of the first cavity including a variable-permittivity medium that is exposed at a top of the first cavity;
a first conductive plate extending along at least part of a vertical dimension of the first cavity;
a second conductive plate extending along at least a part of the vertical dimension of the first cavity, the first conductive plate and the second conductive plate disposed so that the variable-permittivity medium separates opposing surfaces of the first conductive plate and the second conductive plate;
the outer housing having a bottom portion forming a second cavity, the second cavity including means for measuring an electromagnetic characteristic of a capacitor formed by the first conductive plate, the second conductive plate, and the variable-permittivity medium, the second cavity further including means for transmitting information indicative of the electromagnetic characteristic of the capacitor to an irrigation controller.

18. The precipitation sensor of claim 17, wherein the means for measuring the electromagnetic characteristic comprises a voltage source in communication with the capacitor and an amplitude modulation detector in communication with the capacitor.

19. The precipitation sensor of claim 17, wherein the means for measuring the electromagnetic characteristic comprises a voltage source in communication with the capacitor and Wheatstone bridge in communication with the capacitor.

20. The precipitation sensor of claim 17, where in the variable-permittivity medium includes at least one of ceramic and paper.
